(19) United States
(12) Patent Application Publication
(10) Pub. No.: US 2016/0009011 A1
(43) Pub. Date: Jan. 14, 2016

(54) APPARATUS FOR MANUFACTURING LIGHT GUIDE PLATE

(71) Applicant: SHENZHEN CHINA STAR OPTOELECTRONICS TECHNOLOGY CO. LTD., Shenzhen (CN)

(72) Inventor: Hu HE, Shenzhen (CN)

(21) Appl. No.: 14/416,753

(22) PCT Filed: Jul. 16, 2014
(86) PCT No.: PCT/CN2014/082334

§ 371 Date: Jan. 23, 2015

(30) Foreign Application Priority Data
Jul. 10, 2014 (CN) 201410326527.3

(51) Int. Cl. B29C 47/00; F21V 8/00

(52) U.S. Cl. CPC B29C 47/0019; G02B 6/0065; B29L 2011/0075

(57) ABSTRACT

The present disclosure relates to the technical field of liquid crystal display. Specifically, it relates to an apparatus for manufacturing light guide plate. The apparatus comprises: a feeding unit having a slit-shaped discharge port, an extrusion unit comprising a conveying roller for conveying the raw material and an extrusion roller for extruding the raw material, and a cutting unit for cutting the light guide plate guided out of the extrusion unit, wherein an elongated recess depressing toward the interior of the extrusion roller is disposed on a roller body of the extrusion roller, in order to manufacture a light guide plate having a varying thickness. The apparatus has the advantages of high production efficiency.

### CROSS REFERENCE TO RELATED APPLICATION

The present application claims benefit of Chinese patent application CN 201410326527.3, entitled “Apparatus for Manufacturing Light Guide Plate” and filed on Jul. 10, 2014, which is incorporated herein by reference.

### TECHNICAL FIELD

The present disclosure relates to the technical field of liquid crystal display. Specifically, it relates to an apparatus for manufacturing light guide plate.

### TECHNICAL BACKGROUND

Large-size side-edge light emitting diode (LED) backlight source tends to be thinner as it is developed. Therefore, the thickness of a light guide plate is becoming reduced, for example, from 4 mm, the original value, to 3 mm, further to 2 mm, and even thinner. Due to the decreased thickness, a reduced cost of the light guide plate, a lighter module, and even a more elegant appearance can be achieved.

However, on the other hand, a thin-type light guide plate can also cause some problems. Typically, the light coupling efficiency of a thin light guide plate can be reduced due to the limitation of the size of a light emitting diode (LED).

FIG. 1 schematically shows the light path of a relatively thick light guide plate in the prior art. The arrows therein indicate the transmission of light from a light emitting element 1. The light emitting element 1 is an LED 7030 having a light emitting surface with a width of 2.6 mm. The thickness of light guide plate 2 in FIG. 1 is 3 mm.

FIG. 2 schematically shows the light path of a relatively thin light guide plate in the prior art. The arrows therein indicate the transmission of light from the light emitting element 1. The light emitting element 1 is an LED 7030 having a light emitting surface with a width of 2.6 mm. The thickness of light guide plate 2 in FIG. 2 is 2 mm.

Through a comparison of FIG. 2 with FIG. 1, it is easy to understand that since the light guide plate 2 in FIG. 2 has a decreased thickness which is even lower than the width of the light emitting surface of the light emitting element 1, part of the light fails to enter the light guide plate 2.

Therefore, it is easy to understand that the light coupling efficiency between the LED 7030 (the light emitting surface of which has a width of 2.6 mm) and the light guide plate with a thickness of 2 mm as shown in FIG. 2 is far smaller than that between the LED 7030 and the light guide plate with a thickness of 3 mm as shown in FIG. 1. In this case, loss in light energy can be incurred.

The idea of using a wedge-shaped light guide plate is thus derived. FIG. 3 shows a typical light guide plate having a wedge-shaped projection on the light incident side thereof. That is, a thickness T₁ of the light incident side of the light guide plate is larger than a thickness T₂ of the rest area thereof. With such a light guide plate, not only the light coupling efficiency between a large size light emitting element 10 (LED) and a thin light guide plate 20 can be improved, but also a relatively small thickness T₂ of the light guide plate 20 in most area thereof can be achieved.

A traditional wedge-shaped light guide plate is formed by molding process or injection molding process. The above processes are restricted in terms of size. Taking injection molding process as an example, at present only a light guide plate of 32 inches at best can be obtained due to the limitation of the machine tonnage. No forming process or related equipment exists yet in the prior art for producing a wedge-shaped light guide plate of larger size.

### SUMMARY OF THE INVENTION

In order to solve the problem in the prior art of being unable to manufacture a wedge-shaped light guide plate of required size (relatively large), the present disclosure provides an apparatus for manufacturing light guide plate having a wedge-shaped projection on the light incident side thereof (the typical structure thereof is as shown in FIG. 3). In the meantime, as compared with the prior art, a light guide plate of larger size can be manufactured by the apparatus according to the present disclosure without being limited by the design of the apparatus itself.

The present disclosure provides an apparatus for manufacturing light guide plate. According to embodiment 1, the apparatus comprises a feeding unit having a slit-shaped discharge port for supplying raw material of the light guide plate, an extrusion unit comprising a conveying roller for conveying the raw material and an extrusion roller for extruding the raw material, and a cutting unit for cutting the light guide plate guided out of the extrusion unit, wherein an elongated recess depressing toward the interior of the extrusion roller is disposed on a roller body of the extrusion roller, in order to manufacture a light guide plate having a varying thickness.

According to embodiment 2 which is obtained through improvements on the basis of embodiment 1, the conveying roller is located at one side of the raw material and the extrusion roller is located at the other side thereof, and the conveying roller is disposed at a position corresponding to the extrusion roller for cooperation therewith. The extrusion roller and a corresponding conveying roller form paired rollers for extruding the raw material together, and the rest conveying rollers are mainly used to convey the raw material.

According to embodiment 3 which is obtained through improvements on the basis of embodiment 2, the apparatus comprises only one extrusion roller, and in the extrusion unit, the rotating direction of the roller body of the extrusion roller and that of the roller body of the conveying roller are consistent with the advancing direction of the raw material. By means of which, the instantaneous rolling contact portions in the whole system all move toward the same direction.

According to embodiment 4 which is obtained through improvements on the basis of embodiment 2, the recess surrounds the roller body of the extrusion roller along the entire circumference thereof, and the extension direction of the recess is perpendicular to a central rotating axle of the extrusion roller. The wedge-shaped projection of a light guide plate thus obtained extends along the advancing direction (i.e. the rotating direction of the roller body) of the light guide plate.

According to embodiment 5 which is obtained through improvements on the basis of embodiment 4, the recess is located at an axial end of the roller body.

According to embodiment 6 which is obtained through improvements on the basis of embodiment 4, the recess is located at an axial center of the roller body.

Certainly, the number and position of recess can be adjusted according to the relationships between the axial length of the roller body and the size of the target light guide plate.

According to embodiment 7 which is obtained through improvements on the basis of embodiment 2, the recess extends axially from one end of the roller body of the extrusion roller to the other end thereof, the extension direction of the recess being parallel to the central rotating axle of the extrusion roller. The wedge-shaped projection of a light guide plate thus obtained extends along a direction perpendicular to the advancing direction of the light guide plate, i.e. along an axial direction of the roller body.

According to embodiment 8 which is obtained through improvements on the basis of embodiment 7, a plurality of recesses are distributed on the circumference of the roller body of an extrusion roller at regular intervals.

According to embodiment 9 which is obtained through improvements on the basis of embodiment 8, two recesses are arranged on an extrusion roller.

According to embodiment 10 which is obtained through improvements on the basis of embodiment 7, only one recess is arranged on an extrusion roller.

Certainly, the number and position of recess can be adjusted according to the relationships between the perimeter of the roller body and the size of the target light guide plate.

According to embodiment 11 which is obtained through improvements on the basis of any one of embodiments 7 to 10, the cross section of the recess is in the shape of a sector, the side walls of which form the sides of the sector and an opening thereof forms a long arc of the sector. A projection (relatively thick area) on the light guide plate extruded by such a recess is wedge shaped.

According to embodiment 12 which is obtained through improvements on the basis of any one of embodiments 7 to 10, the guide light plate guided out of the extrusion unit comprises a relatively thin area and a relatively thick area and the cutting unit cuts the light guide plate on the relatively thick area. In this case, a large light guide plate of specified size having a wedge-shaped projection (relatively thick area) on the light incident side thereof can be obtained. After subsequent forming and polishing steps, the light guide plate can be applied to a display device.

A light guide plate having a wedge-shaped projection on the light incident side thereof can be manufactured through the apparatus according to the present disclosure. Such a light guide plate can be cut into any size as required, especially a size larger than that can be obtained in the prior art. On the other hand, the whole manufacturing process can be implemented in the apparatus. Therefore, the advantages of smooth operation, high production efficiency, easy maintenance, and low integration cost can be realized.

The above technical features can be combined in any manner or substituted with equivalent technical features, as long as the objective of the present disclosure is met.

### BRIEF DESCRIPTION OF THE ACCOMPANYING DRAWINGS

The present disclosure will be described in details based on the following embodiments with reference to the accompanying drawings. In which:

FIG. 1 schematically shows the light path of a relatively thick light guide plate in the prior art;

FIG. 2 schematically shows the light path of a relatively thin light guide plate in the prior art;

FIG. 3 schematically shows the structure of a light guide plate to be manufactured by an apparatus according to the present disclosure;

FIG. 4 schematically shows the structure of an apparatus for making light guide plate according to Example 1 of the present disclosure;

FIG. 5 shows a side view of the apparatus for making light guide plate according to Example 1 of the present disclosure;

FIG. 6 shows an extrusion roller of the apparatus for making light guide plate according to Example 1 of the present disclosure;

FIG. 7 shows a finished light guide plate manufactured by the apparatus for making light guide plate according to Example 1 of the present disclosure;

FIG. 8 shows a side view of the light guide plate of FIG. 7;

FIG. 9 shows an extrusion roller of the apparatus for manufacturing light guide plate according to Example 2 of the present disclosure;

FIG. 10 shows a finished light guide plate manufactured by the apparatus for making light guide plate according to Example 2 of the present disclosure;

FIG. 11 shows a side view of an apparatus for making light guide plate according to Example 3 of the present disclosure;

FIG. 12 shows a perspective view of a roller body of an extrusion roller of the apparatus for making light guide plate according to Example 3 of the present disclosure;

FIG. 13 shows a side view of the roller body of the extrusion roller in FIG. 12 observed along an axial direction thereof;

FIG. 14 shows the size relationship between the roller body of the extrusion roller in FIG. 13 and the light guide plate obtained;

FIG. 15 shows an alternative structure of the apparatus for making light guide plate according to Example 3 of the present disclosure; and

FIG. 16 shows an extrusion roller of an apparatus for making light guide plate according to Example 4 of the present disclosure.

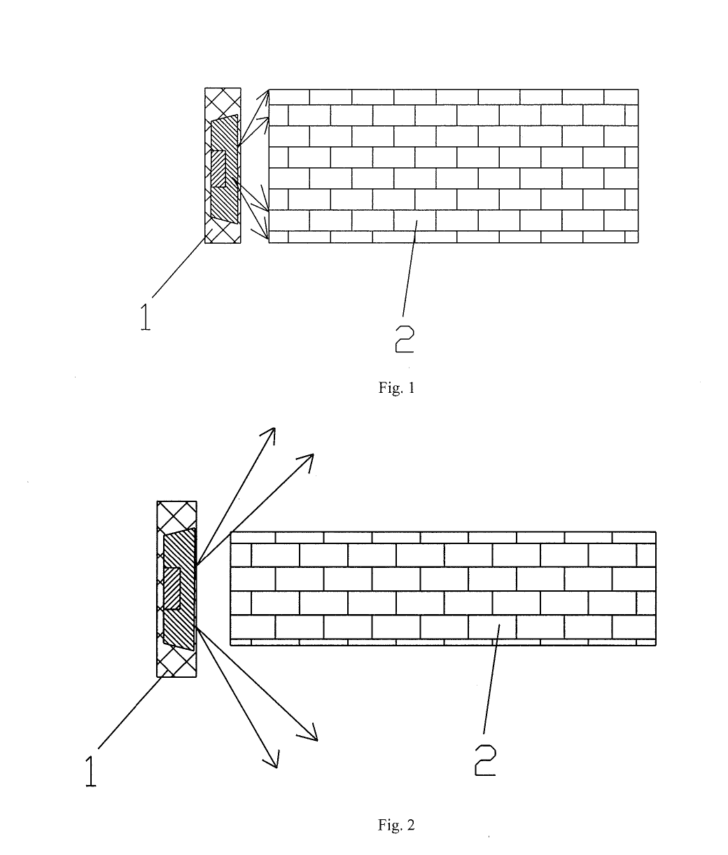

In the drawings, the same components are indicated with the same sign. The drawings are not drawn to actual scale.

### DETAILED DESCRIPTION OF THE EMBODIMENTS

The present disclosure will be further described with reference to the accompanying drawings.

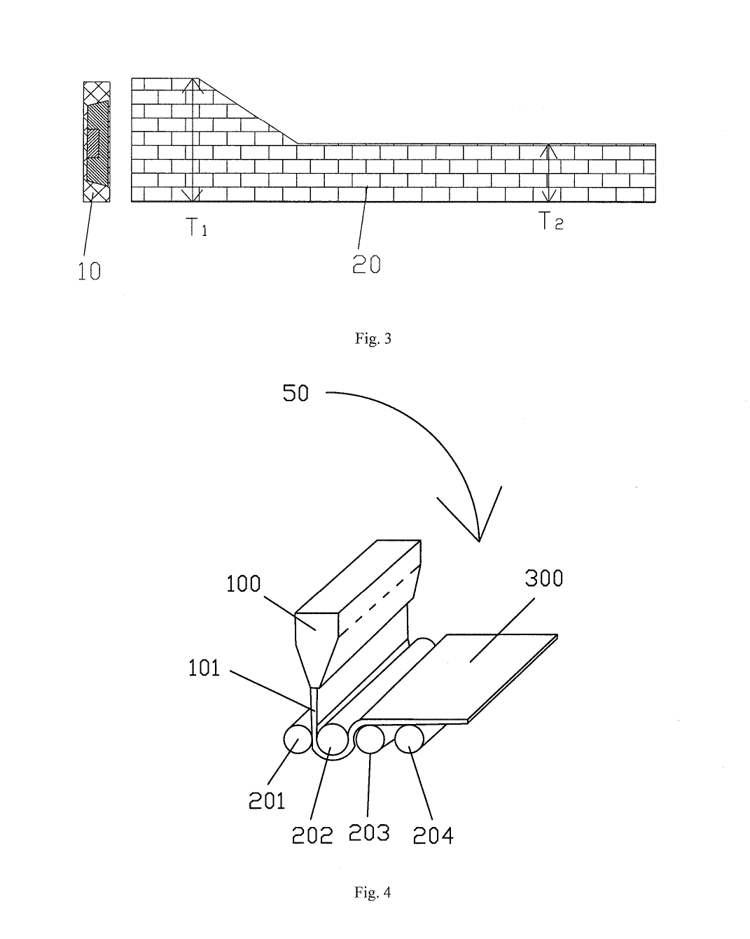

As described above, FIG. 3 shows a light guide plate 20 having a wedge-shaped projection on the light incident side thereof. The light guide plate 20 is the light guide plate to be manufactured by an apparatus according to the present disclosure. Generally speaking, the objective of the present disclosure is to manufacture a light guide plate having a varying thickness. The specific form of the light guide plate is not limited to that as shown in FIG. 3. For example, the wedge-shaped projection can be arranged on another position of the light guide plate, or the projection can have a cross section of a different shape, such as rectangle or arc.

As clearly shown in FIG. 3, a thickness T₁ of a light incident side of the light guide plate 20 is larger than a thickness T₂ of the rest area thereof. With such a light guide plate, not only the light coupling efficiency between a large size light emitting element 10 (LED) and a thin light guide plate 20 can be improved, but also a relatively small thickness T₂ of the light guide plate 20 on most area thereof can be guaranteed.

The manufacturing process of a large size flat light guide plate comprises the following steps. First, molten macromolecule material (typically, polymethyl methacrylate (PMMA) or styrene-methyl methacrylate copolymer (MS)) is extruded through several extrusion rollers. Second, the extruded material is cooled. A large light guide plate is thus obtained. The apparatus according to the present disclosure is developed and improved based on the above technical principle.

FIG. 4 schematically shows an apparatus 50 for manufacturing light guide plate according to Example 1 of the present disclosure.

As shown in FIG. 4, the apparatus 50 in Example 1 comprises a feeding unit 100. The feeding unit 100 can be a container having a slit-shaped discharge port for supplying raw material 101 of the light guide plate. After the raw material 101 flows out of the feeding unit 100, it forms a roughly plate shaped body due to the limitation of the slit-shaped discharge port. The plate shape of the raw material 101 at this moment is merely for the convenience of the following steps, and is a little deviated from the final form of the light guide plate.

The apparatus 50 further comprises an extrusion unit. The extrusion unit comprises a conveying roller for conveying the raw material 101, and an extrusion roller for extruding the raw material 101. According to Example 1 as shown in FIG. 4, the apparatus 50 comprises conveying rollers 201, 203, and 204, as well as extrusion roller 202. For an easy operation, the conveying rollers 201, 203, and 204 are arranged on one side of the raw material 101, and the extrusion roller 202 alone is arranged on the other side thereof. The conveying roller 201 is disposed at a position corresponding to the extrusion roller 202 for cooperation therewith. The extrusion roller 202 and the conveying roller 201 form paired rollers for extruding the raw material 101 together (detailed description will be provided later). Then, the extrusion roller 202 further forms paired rollers with the conveying roller 203. The main function of the conveying roller 204 is to convey the raw material 101.

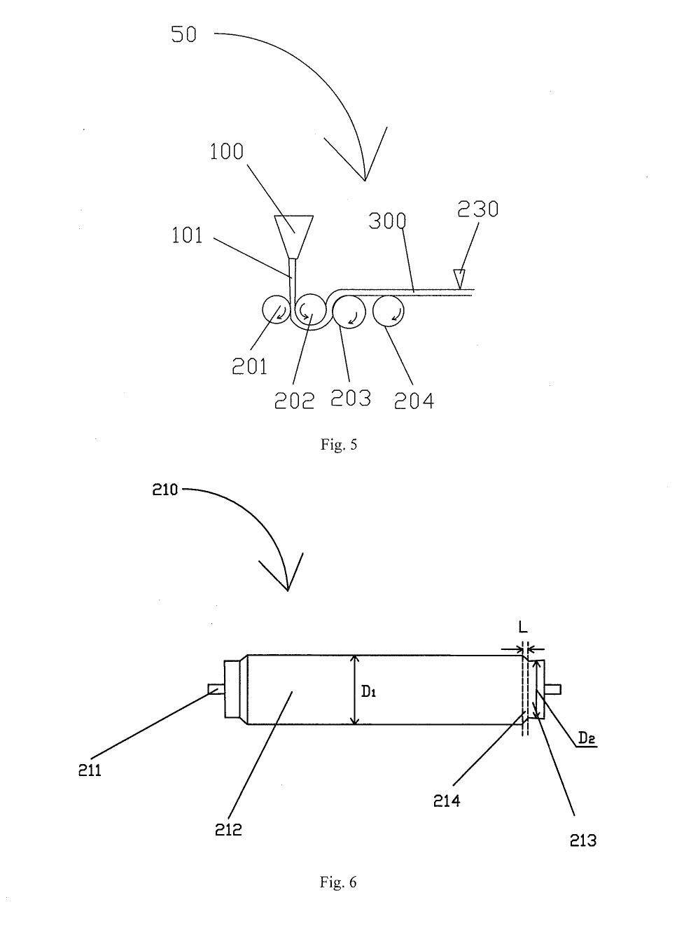

FIG. 5 shows a side view of the apparatus in FIG. 4. The arrows therein indicate the rotating directions of the conveying rollers 201, 203, and 204 and that of the extrusion roller 202. As shown in FIG. 5, the rotating directions of all of the extrusion roller and conveying rollers in the extrusion unit (consisting of conveying rollers 201, 203, and 204 and extrusion roller 202 in Example 1) are consistent with the advancing direction of the raw material 101. As shown in FIG. 5, the raw material 101 advances from left to right. The conveying rollers 201, 203, and 204 on one side of the raw material 101 rotate clockwisely and the extrusion roller 202 on the other side thereof rotates counter-clockwisely, such that the instantaneous rolling contact portions in the whole system all move toward the same direction.

As shown in FIG. 5, the apparatus 50 further comprises a cutting unit 230 for cutting a light guide plate 300 guided out of the extrusion unit. It is understandable that after the extrusion, the raw material 101 has become a light guide plate 300 having a shape as required, which, however, is larger than needed at this stage. Thus it is necessary to use the cutting unit 230 to cut the light guide plate 300 into a size that matches a display device of specific model.

FIG. 6 shows an extrusion roller 210 (corresponding to the extrusion roller 202 as shown in FIGS. 4 and 5) of the apparatus according to Example 1 of the present disclosure. According to FIG. 6, an elongated recess 213 depressing toward the interior of the extrusion roller 210 is disposed on a roller body 212 of the extrusion roller 210. The raw material 101 is extruded by the extrusion roller 210, and thus formed a light guide plate having a varying thickness (such as the light guide plate 20 as shown in FIG. 3). Referring to FIG. 6, the recess 213 entirely surrounds the roller body 212 of the extrusion roller 210 along the circumferential direction thereof, and an extension direction of the recess 213 is perpendicular to a central rotating axle 211 of the extrusion roller 210. In other words, the recess 213 extends around the entire circumference of the roller body 212.

It can be clearly seen from FIG. 6 that the elongated recess 213 is located at an axial end of the roller body 212. According to specific manufacturing requirements of size and model, recess or recesses 213 can be arranged at an axial end of the roller body 212 or at both axial ends thereof. The radial dimension of the roller body 212 at the recess 213 is apparently smaller than that of the roller body 212 on the rest area thereof. That is, a diameter D₂ of the roller body 212 at the recess 213 on the axial end is smaller than a diameter D₁ of the roller body 212 on the rest area. The recess 213 further comprises an inclined side wall 214 having an axial width L. The side wall 214 is delimited by the dash lines in FIG. 6.

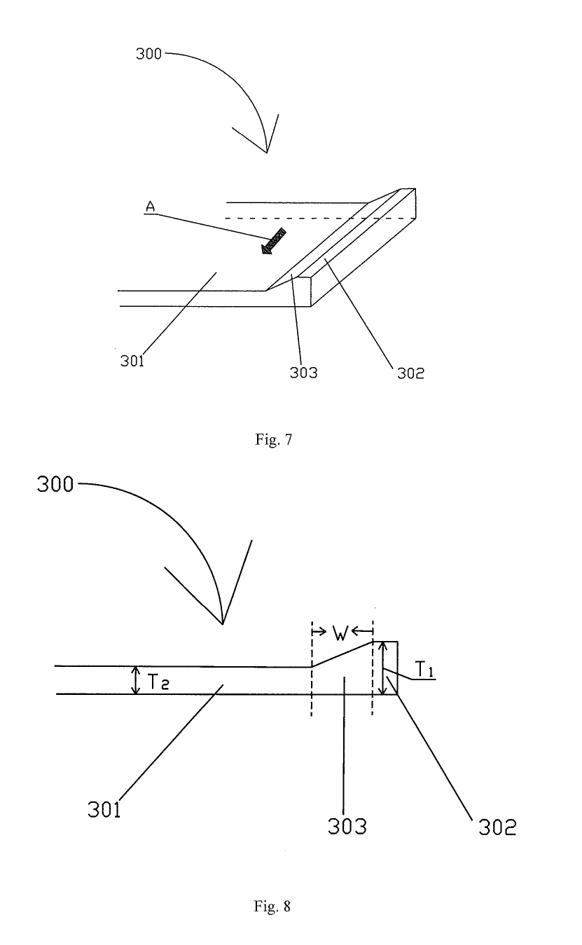

FIG. 7 shows a finished light guide plate 300 manufactured by the apparatus for manufacturing light guide plate according to Example 1 of the present disclosure. As shown in FIG. 7, the light guide plate 300 comprises a relatively thin area 301, a relatively thick area 302, and a slope area 303 having certain inclination between the relatively thin area 301 and the relatively thick area 302. The hatched arrow A in FIG. 7 indicates the rotating direction of a roller body of an extrusion roller exerting upon the light guide plate 300.

FIG. 8 shows a side view of the light guide plate in FIG. 7. The slope area 303 is delimited by two dash lines in FIG. 8. It is easy to understand that the corresponding surfaces between the roller body 212 of the extrusion roller 210 and the light guide plate 300 engage with each other in a concave-convex manner. Referring to FIGS. 6 and 8, the wider portion (the non-recessed area) of the roller body 212 corresponds to the relatively thin area 301 of the light guide plate 300. The recess 213 on the roller body 212 corresponds to the relatively thick area 302 of the light guide plate 300. The side wall 214 of the roller body 212 corresponds to the slope area 303 of the light guide plate 300.

Furthermore, the size of the roller body 212 is also correlative to that of the wedge-shaped light guide plate 300, as shown by the equation D₁−D₂=2(T₁−T₂), wherein D₁ is the diameter of the wider portion of the roller body 212, D₂ is the diameter of the roller body 212 at the recess 213, T₁ is the thickness of the relatively thick area of the light guide plate 300, and T₂ is the thickness of the relatively thin area of the light guide plate 300. Of course, the above equation of the size relationship reflects merely a theoretical value. It is easy for a person skilled in the art to understand that certain tolerance of the product size is inevitable in actual manufacturing process. On another aspect, an axial width L of the side wall 214 of the recess 213 of roller body 212 equals to an axial width W of the slope area 303 of the light guide plate 300.

Referring to FIG. 5 again, in Example 1, the wedge-shaped projection (the relatively thick area 302) of the light guide plate 300 extends along the advancing direction of the raw material 101 of the light guide plate. After the roll forming process, the light guide plate 300 obtained can be cut along its edge in a machine direction (MD) and polished through a forming machine stand, thereby further forming a wedge-shaped projection on a light incident side of the finished light guide plate 300.

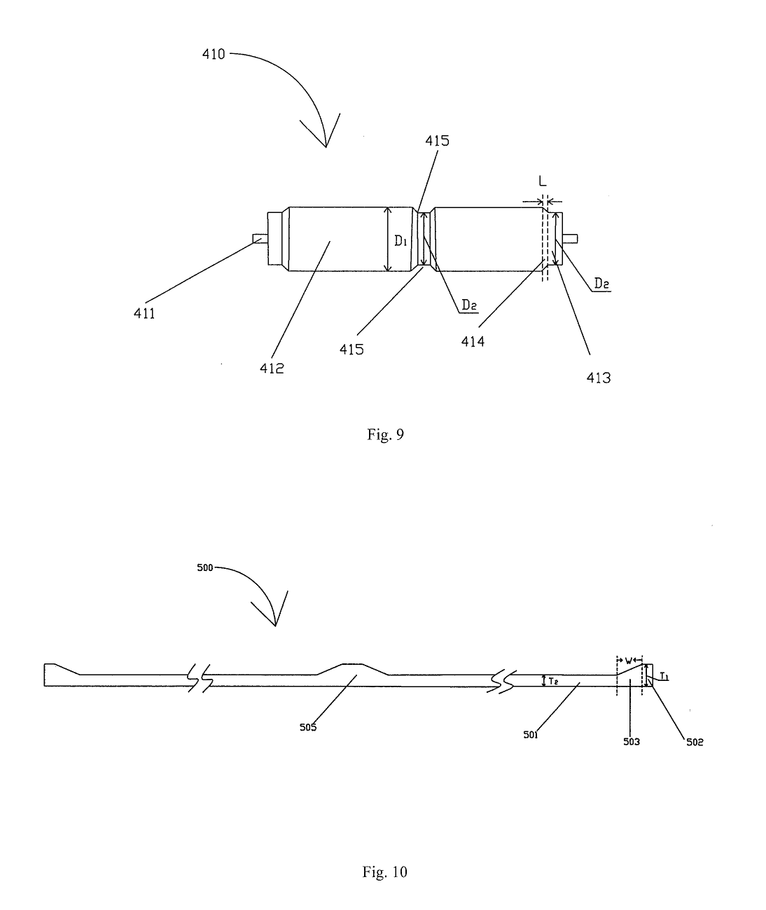

FIG. 9 shows an extrusion roller 410 of an apparatus for manufacturing light guide plate according to Example 2 of the present disclosure. The structure of the apparatus in Example 2 is substantially the same with that of the apparatus in Example 1 as shown in FIGS. 4 and 5, and thus will not be described in details herein. The main difference of Example 2 from Example 1 is that in Example 2, the extrusion roller 210 as shown in FIG. 6 is replaced with the extrusion roller 410 as shown in FIG. 9, which factions as the extrusion roller 202 in FIGS. 4 and 5.

As shown in FIG. 9, elongated recesses 413 and 415 depressing toward the interior of the extrusion roller 410 are disposed on a roller body 412 of the extrusion roller 410. The recess 413 is disposed at an axial end of the roller body 412, and the recess 415 is disposed at an axial center of the roller body 412.

By extruding the raw material 101 through the extrusion roller 410, a light guide plate having a varying thickness (such as the light guide plate 20 as shown in FIG. 3) can be manufactured. Referring to FIG. 9, the recesses 413 and 415 surround the roller body 412 of the extrusion roller 410 along the entire circumference thereof, and the extensions thereof are perpendicular to a central rotating axle 411 of the extrusion roller 410. In other words, each of the recesses 413 and 415 extend along the circumference of the roller body 412 for 360 degrees.

The diameter of the roller body 412 at each of the recesses 413 and 415 is apparently smaller than that of the rest area of the roller body 412, i.e. a diameter D₂ of the recess 415 at the axial center of the roller body 412 is smaller than a diameter D₁ at the non-recessed area of the roller body 412.

FIG. 10 shows a finished light guide plate 500 manufactured by the apparatus for manufacturing light guide plate according to Example 2 of the present disclosure. It is easy to understand that the corresponding surfaces between the roller body 412 of the extrusion roller 410 and the light guide plate 500 engage with each other in a concave-convex manner. Referring to FIGS. 9 and 10, the wider portion (the non-recessed area) of the roller body 412 corresponds to a relatively thin area 501 of the light guide plate 500. The recess 413 at the axial end of the roller body 412 corresponds to a relatively thick area 502 of the edge of the light guide plate 500. The recess 415 at the axial center of the roller body 412 corresponds to a relatively thick area 505 at the center of the light guide plate 500.

When the axial length of the extrusion roller 412 is larger than twice the required length of a light guide plate, Example 2 can be adopted. That is, an elongated recess 415 which extends perpendicular to the central rotating axle 411 of the extrusion roller 410 can be disposed at the axial center of the roller body 412, and surrounds the entire circumference of the roller body 412.

Of course, the number and position of recess in Example 1 and Example 2 are only exemplary but not restrictive. Based on the axial length of the roller body and the required size of the light guide plate, the number and position of elongated recess on the roller body of the extrusion roller can be adjusted accordingly. A plurality of elongated recesses which are perpendicular to the central rotating axle of the roller body and surround the circumference thereof can also be arranged on the roller body at regular intervals. Specifically, the elongated recess can be a slot having a trapezoidal cross section.

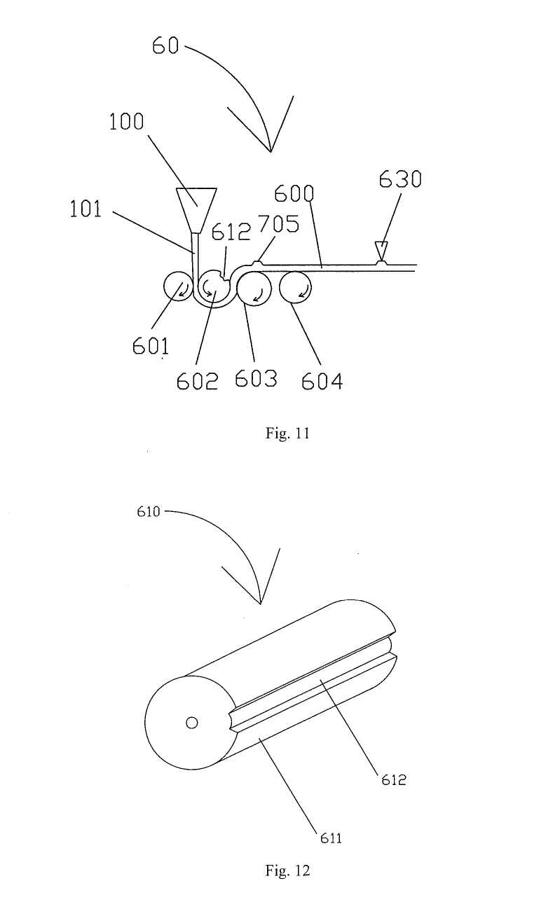

FIG. 11 shows a side view of an apparatus for manufacturing light guide plate according to Example 3 of the present disclosure. As shown in FIG. 11, an apparatus 60 in Example 3 comprises a feeding unit 100. Further, the apparatus 60 comprises an extrusion unit, comprising conveying rollers for conveying raw material 101 of the light guide plate and an extrusion roller for extruding the raw material 101. In Example 3 as shown in FIG. 11, the apparatus 60 comprises conveying rollers 601, 603, and 604, as well as an extrusion roller 602. For an easy operation, the conveying rollers 601, 603, and 604 are arranged on one side of the raw material 101, and the extrusion roller 602 alone is arranged on the other side thereof. The conveying roller 601 is arranged on a position corresponding to the extrusion roller 602 for cooperation therewith. The extrusion roller 602 and the conveying roller 601 form paired rollers for extruding the raw material 101 together (detailed description will be provided later). And then the extrusion roller 602 pairs with the conveying roller 603. The conveying roller 604 is mainly used to convey the raw material 101.

FIG. 11 further indicates the rotating directions of the conveying rollers 601, 603, and 604 and that of the extrusion roller 602 with arrows. As shown in FIG. 11, the rotating directions of all of the extrusion roller and conveying rollers in the extrusion unit (consisting of conveying rollers 601, 603, and 604 and an extrusion roller 602 in Example 3) are consistent with the advancing direction of the raw material 101. In FIG. 11, the raw material 101 advances from left to right. The conveying rollers 601, 603, and 604 on one side of the raw material 101 rotate clockwisely, and the extrusion roller 602 on the other side thereof rotates counter-clockwisely, such that the instantaneous rolling contact portions in the whole system all move toward the same direction.

As shown in FIG. 11, the apparatus 60 further comprises a cutting unit 630 for cutting the light guide plate 600 guided out of the extrusion unit. It is easy to understand that after the extrusion process through the extrusion unit, the raw material 101 has become a light guide plate 600 having a shape as required, which, however, is larger than needed at this stage. Thus it is necessary to use the cutting unit 630 cuts the light guide plate 600 into a size that matches a display device of specific model.

FIG. 12 shows a perspective view of a roller body of an extrusion roller of the apparatus for manufacturing light guide plate according to Example 3 of the present disclosure. In Example 3, the extrusion roller 602 of the apparatus 60 as shown in FIG. 11 is replaced with the extrusion roller 610 as shown in FIG. 12.

As shown in FIG. 12, an elongated recess 612 is arranged on a roller body 611 of the extrusion roller 610. The recess 612 extends along an axial direction of the roller body 611 from an axial end of the roller body 611 to the other axial end thereof. An extension direction of the elongated recess 612 is parallel to a central rotating axle of the extrusion roller 610. Although the central rotating axle is not shown in FIG. 12, it is easy for a person skilled in the art to understand that the central rotating axle is usually located at the central axle of the roller body.

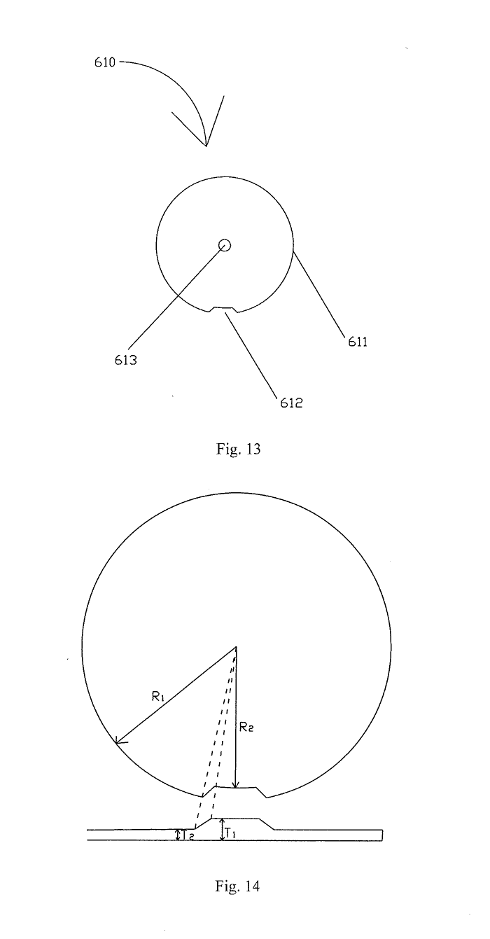

FIG. 13 shows a side view of the roller body 611 of the extrusion roller 610 as shown in FIG. 12 observed from an axial direction thereof. As shown in FIG. 13, the elongated recess 612 depressing toward the interior (i.e. depressing toward a central rotating axle 613) of the extrusion roller 610 is arranged on the roller body 611. Preferably, the cross section of the recess 612 is in the shape of a sector, the side walls of which form the sides of the sector and the opening side forms the long arc of the sector. In this case, a projection (relatively thick area) on the light guide plate obtained under the extrusion of the recess 612 is wedge shaped.

FIG. 14 shows the size relationship between the roller body 611 of the extrusion roller 610 in FIG. 13 and a light guide plate obtained, wherein the upper part of FIG. 14 shows a side view of the roller body 611 of the extrusion roller 610 observed from an axial direction thereof, and the lower part of FIG. 14 shows a side view of a light guide plate obtained by the extrusion of the extrusion roller 610.

A radius R₂ at the recess of the roller body of the extrusion roller as shown in FIG. 14 is smaller than a radius R₁ of the roller body at the rest area (the non-recessed area). On another aspect, the corresponding surfaces between the roller body of the extrusion roller and the light guide plate engage with each other in a concave-convex manner. The rest area of the roller body (the non-recessed area) corresponds to a relatively thin area of the light guide plate, and the recess on the roller body corresponds to a relatively thick area of the light guide plate. Thus, a thickness T₁ of the relatively thick area of the light guide plate is larger than a thickness T₂ of the relatively thin area of the light guide plate.

The size of the roller body is also correlative to that of the wedge-shaped light guide plate, as shown in the equation R₁−R₂=T₁−T₂, wherein R₂ is the radius of the roller body at the recess, R₁ is the radius of the roller body on the rest area (the non-recessed area), T₁ is the thickness of the relatively thick area of the light guide plate, and T₂ is the thickness of the relatively thin area of the light guide plate. Of course, the above equation of the size relationship merely reflects a theoretical value. It is easy for a person skilled in the art to understand that certain tolerance of the product size is inevitable in actual manufacturing process. As shown in the drawings, an inclined side wall is further provided between the recess and the non-recessed area of the roller body, thus a slope area having a certain inclination also exists between the relatively thin area and the relatively thick area of the light guide plate. It is easy to understand that the dimension of the side wall along a circumferential direction equals to that of the slope area along a corresponding circumferential direction.

Referring to FIG. 11 again, when a large light guide plate 600 is cooled, it is cut by the cutting unit 630 along a wedge-shaped projection 705 (the relatively thick area), so as to obtain a light guide plate of specified size having a wedge-shaped projection (the relatively thick area) at a light incident side thereof. After the following forming and polishing steps, the light guide plate can be subsequently applied to a display device.

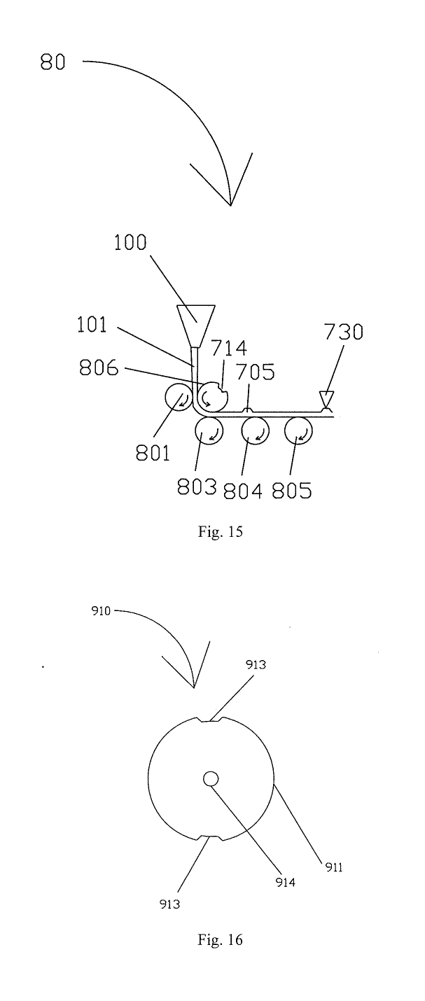

FIG. 15 shows an alternative structure for the apparatus in Example 3 of the present disclosure. An apparatus 80 as shown in FIG. 15 is substantially the same as the apparatus 60 as shown in FIG. 11, and thus will not be described in details. The main differences of the apparatus 80 from the apparatus 60 are the number and positions of the conveying rollers. As shown in FIG. 15, the apparatus 80 comprises four conveying rollers 801, 803, 804, and 805, as well as an extrusion roller 806 having a groove 714. The conveying rollers and the extrusion roller are no longer at the same level. The conveying roller 801 and the extrusion roller 806 are located at a higher level, and form paired rollers for extruding raw material 101 of the light guide plate together. Then, the extrusion roller 806 pairs with the conveying roller 803. The conveying rollers 804 and 805 are mainly used to convey the raw material. A cutting unit 730 is used to cut the light guide plate.

FIG. 16 shows an extrusion roller of an apparatus for manufacturing light guide plate according to Example 4 of the present disclosure. The structure of the apparatus in Example 4 is substantially the same as that of the apparatus in Example 3 as shown in FIG. 11, and thus will not be described in details. The main difference of Example 4 from Example 3 is that the extrusion roller 610 as shown in FIG. 12 is replaced with an extrusion roller 910 as shown in FIG. 16, which functions as the extrusion roller 602 as shown in FIG. 11.

The extrusion roller 910 comprises a central rotating axle 914 and a roller body 911. Two elongated recesses 913 are arranged on the roller body 911. The recesses 913 extend along an axial direction of the roller body 911 from one axial end to the other thereof.

As a variation of Example 4, the roller body of the extrusion roller can comprise a plurality of elongated recesses, which extend along an axial direction of the roller body and are distributed on the circumference thereof at regular intervals.

The number of recess on the roller body can be determined according to the perimeter of the roller body and the corresponding size of the light guide plate.

(1) Take a 55-inch light guide plate with its short side being the light incident side as an example, the long side has a length of 1240 mm. Accordingly, the diameter of a roller body is 400 mm (the perimeter thereof is about 1260 mm). In this case, only one elongated recess along an axial direction of the roller body is needed for obtaining a light guide plate having a wedge-shaped projection on the short light incident side thereof.

(2) Take a 32-inch light guide plate with its short side being the light incident side as an example, the diameter of a roller body is 500 mm (the perimeter thereof is about 1570 mm). When a light guide plate having a wedge-shaped projection is manufactured, two elongated recesses spaced apart for 180 degrees relative to each other can be disposed on the roller body along an axial direction thereof, so that two light guide plates each having a wedge-shaped projection formed on the corresponding short light incident side can be manufactured by rotating the roller body for one round.

If necessary, the elongated recesses in Example 1 and Example 2 and those in Example 3 and Example 4 can be combined together, so as to obtain a required light guide plate having projections on the surface thereof.

While the present disclosure have been described with reference to preferred embodiments, various modifications can be made to the present disclosure without departing from the scope and spirit of the present disclosure and components in the present disclosure could be substituted with equivalents. In particular, as long as there is no structural conflict, all the technical features mentioned in all the embodiments may be combined together in any manner. The present disclosure is not limited to the specific embodiments disclosed in the description, but rather includes all the technical solutions falling into the scope of the claims.

1. An apparatus for manufacturing light guide plate, comprising:
a feeding unit having a slit-shaped discharge port for supplying raw material of the light guide plate,
an extrusion unit comprising a conveying roller for conveying the raw material and an extrusion roller for extruding the raw material, and
a cutting unit for cutting the light guide plate guided out of the extrusion unit,
wherein an elongated recess depressing toward the interior of the extrusion roller is disposed on a roller body of the extrusion roller, in order to manufacture a light guide plate having a varying thickness.

2. The apparatus according to claim 1, wherein the conveying roller is located at one side of the raw material and the extrusion roller is located at the other side thereof, and the conveying roller is disposed at a position corresponding to the extrusion roller for cooperation therewith.

3. The apparatus according to claim 2, wherein the apparatus comprises only one extrusion roller, and in the extrusion unit, the rotating direction of the roller body of the extrusion roll and that of the roller body of the conveying roller are consistent with the advancing direction of the raw material.

4. The apparatus according to claim 2, wherein the recess surrounds the roller body of the extrusion roller along the entire circumference thereof, and the extension direction of the recess is perpendicular to a central rotating axle of the extrusion roller.

5. The apparatus according to claim 4, wherein the recess is located at an axial end of the roller body.

6. The apparatus according to claim 4, wherein the recess is located at an axial center of the roller body.

7. The apparatus according to claim 2, wherein the recess extends axially from one end of the roller body of the extrusion roller to the other end thereof, the extension direction of the recess being parallel to a central rotating axle of the extrusion roller.

8. The apparatus according to claim 7, wherein a plurality of recesses are distributed on the circumference of the roller body of the extrusion roller at regular intervals.

9. The apparatus according to claim 7, wherein the cross section of the recess is in the shape of a sector, the side walls of which form the sides of the sector and an opening thereof forms a long arc of the sector.

10. The apparatus according to claim 8, wherein the cross section of the recess is in the shape of a sector, the side walls of which form the sides of the sector and the opening thereof forms the long arc of the sector.

11. The apparatus according to claim 7, wherein the guide light plate guided out of the extrusion unit comprises a relatively thin area and a relatively thick area, and the cutting unit cuts the light guide plate on the relatively thick area.

12. The apparatus according to claim 8, wherein the guide light plate guided out of the extrusion unit comprises a relatively thin area and a relatively thick area, and the cutting unit cuts the light guide plate on the relatively thick area.
